(19) United States
(12) Patent Application Publication
(10) Pub. No.: US 2015/0223170 A1
(43) Pub. Date: Aug. 6, 2015

(54) METHOD AND APPARATUS FOR RECOGNITION OF INFORMATION CONTAINED IN FRAME

(71) Applicant: Electronics and Telecommunications Research Institute, Daejeon (KR)

(72) Inventors: Kapseok CHANG, Daejeon (KR); Byung-Jae KWAK, Daejeon (KR)

(21) Appl. No.: 14/616,480

(22) Filed: Feb. 6, 2015

(30) Foreign Application Priority Data
Feb. 6, 2014 (KR) 10-2014-0013610
Mar. 10, 2014 (KR) 10-2014-0027920
Feb. 5, 2015 (KR) 10-2015-0017959

(51) Int. Cl. H04W 52/02; H04W 48/16; H04W 56/00

(52) U.S. Cl. CPC H04W 52/0216; H04W 56/001; H04W 48/16; H04W 84/12

(57) ABSTRACT

A method and apparatus for recognition of information contained in a frame are provided. The method includes performing synchronization over a synchronization period of the frame, and recognizing, through an indication block of a listen period included in the frame, whether information exists in the remaining part of the listen period after the indication block.

### CROSS-REFERENCE TO RELATED APPLICATION

This application claims priority to and the benefit of Korean Patent Application Nos. 10-2014-0013610, 10-2014-0027920, and 10-2015-0017959 filed in the Korean Intellectual Property Office on Feb. 6, 2014, Mar. 10, 2014, and Feb. 5, 2015, the entire contents of which are incorporated herein by reference.

### BACKGROUND OF THE INVENTION

(a) Field of the Invention

The present invention relates to a method and apparatus for recognition of information contained in a frame in a distributed network.

(b) Description of the Related Art

In a conventional wireless local area network (WLAN) system, an access point (AP) can provide a terminal with start timing of a beacon and a contention-based time resource domain in a centralized way. In this case, the terminal may associate with the AP and then receive service information (i.e., discovery information) from the AP. Moreover, in the conventional WLAN system, the AP provides information on the start timing of a beacon, and the terminal (particularly, in sleep mode) receives a beacon only for a fixed period of time to recognize whether discovery information about itself exists. In doing so, it is expected to bring power-saving benefits; however, system efficiency may be decreased because every terminal has to connect to an AP to get discovery information.

For example, a terminal A may have to connect to an AP even if the AP connected to the terminal A does not provide a service the terminal A wants. Also, when the AP, connected to a terminal B, provides a service the terminal B wants, the terminal A unnecessarily connected to the AP may have undesirable effects on the terminal B, thus decreasing system efficiency.

Moreover, each terminal still needs some way of increasing system efficiency, not only in a WLAN system with access points, but also in a distributed node system with no APs. The distributed node system includes such a system, where each node acts as a peer to communicate with other peers. That is, in a distributed node system, there is a need for a technique for increasing system efficiency and enhancing power saving by allowing each terminal to know the start timing of a frame and get discovery information before connecting to the system.

### SUMMARY OF THE INVENTION

The present invention has been made in an effort to provide a method and apparatus which can reduce the power consumption of a peer device by recognizing information contained in a frame in a distributed network.

An exemplary embodiment of the present invention provides a method for a terminal to recognize information contained in a frame. The method includes: performing synchronization over a synchronization period of the frame; and recognizing, through an indication block of a listen period included in the frame, whether information in the remaining part of the listen period exists after the indication block.

The recognizing may include: receiving a physical layer signal that is transmitted in the indication block; and recognizing whether the information in the remaining part exists by the received power of the physical layer signal.

The recognizing of whether information exists in the remaining part by the received power of the physical layer signal may include: comparing the received power of the physical layer signal with a threshold value; determining that no information exists in the remaining part if the received power is less than the threshold value; and determining that information exists in the remaining part if the received power is equal to or greater than the threshold value.

The method for the terminal to recognize the information contained in the frame may further include switching to and staying in sleep mode in the remaining part upon recognizing, through the indication block, that no information exists in the remaining part.

The method for the terminal to recognize the information contained in the frame may further include staying in listen mode in the remaining part upon recognizing, through the indication block, that information exists in the remaining part.

The listen period may be a discovery period, the indication block is a discovery indication block, and the remaining part comprises at least one discovery execution block.

The discovery indication block may include a plurality of sub-blocks for indicating the state of the terminal.

The method for the terminal to recognize the information contained in the frame may further include receiving the physical layer signal in one of the sub-blocks.

One of the at least one discovery execution block may include a physical discovery data unit (PDDU) and the header of the PDDU, and the PDDU may include discovery information and a discovery type.

The listen period may be a peering period, the indication block may be a peering indication block, and the remaining part may be a peering execution block.

Another embodiment of the present invention provides a terminal. The terminal may include: at least one processor; a memory; and a radio frequency unit, wherein the at least one processor may execute at least one program stored in the memory, and perform synchronization over a synchronization period of a frame, and recognize, through an indication block of a listen period included in the frame, whether information exists in the remaining part of the listen period after the indication block.

In the recognizing, the at least one processor may receive a physical layer signal that is transmitted in the indication block, and recognize whether the information exists in the remaining part by the received power of the physical layer signal.

In the recognizing of whether information exists in the remaining part by the received power of the physical layer signal, the at least one processor may compare the received power of the physical layer signal with a threshold value, determine that no information exists in the remaining part if the received power is less than the threshold value, and determine that information exists in the remaining part if the received power is equal to or greater than the threshold value.

The at least one processor may switch to and stay in sleep mode in the remaining part upon recognizing, through the indication block, that no information exists in the remaining part.

The at least one processor may stay in listen mode in the remaining part upon recognizing, through the indication block, that information exists in the remaining part.

The listen period may be a discovery period, the indication block may be a discovery indication block, and the remaining part may include at least one discovery execution block.

The discovery indication block may include a plurality of sub-blocks for indicating the state of the terminal.

The radio frequency unit may receive the physical layer signal in one of the sub-blocks.

One of the at least one discovery execution block may include a physical discovery data unit (PDDU) and the header of the PDDU, and the PDDU may include discovery information and a discovery type.

The listen period may be a peering period, the indication block may be a peering indication block, and the remaining part may be a peering execution block.

### BRIEF DESCRIPTION OF THE DRAWINGS

FIG. 1 is a view showing a frame in a distributed node system according to an exemplary embodiment of the present invention.

FIG. 2 is a view showing a synchronization period according to an exemplary embodiment of the present invention.

FIG. 3 is a view showing a discovery period according to an exemplary embodiment of the present invention.

FIG. 4 is a view showing a discovery period according to another exemplary embodiment of the present invention.

FIG. 5 is a view showing a protocol stack according to an exemplary embodiment of the present invention.

FIG. 6 is a view showing a peering period according to an exemplary embodiment of the present invention.

FIG. 7 is a block diagram showing a wireless communication system according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, a peer device (PD) may indicate a terminal, a mobile terminal (MT), an advanced mobile station (AMS), a high reliability mobile station (HR-MS), a subscriber station (SS), a portable subscriber station (PSS), an access terminal (AT), and user equipment (UE), and it may include entire or partial functions of the MT, MS, AMS, HR-MS, SS, PSS, AT, and UE.

In the specification, a base station (BS) may indicate an advanced base station (ABS), a high reliability base station (HR-BS), a node B (NodeB), an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (ARS) serving as a base station, a high reliability relay station (HR-RS) serving as a base station, and a small base station [such as a femto base station (femto BS), a home node B (HNB), a home eNodeB (HeNB), a pico base station (pico BS), a metro base station (metro BS), or a micro base station (micro BS)], and it may include entire or partial functions of the ABS, nodeB, eNodeB, AP, RAS, BTS, MMR-BS, RS, RN, ARS, HR-RS, and small base station.

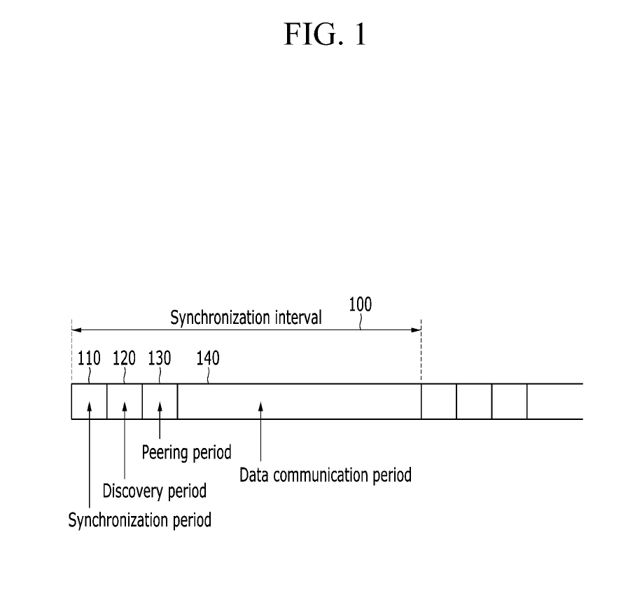

FIG. 1 is a view showing a frame in a distributed node system according to an exemplary embodiment of the present invention.

Referring to FIG. 1, a frame in a distributed network according to an exemplary embodiment of the present invention may include at least one synchronization interval 100, and the synchronization interval 100 includes a synchronization period 110, a discovery period 120, a peering period 130, and a data communication period 140.

The synchronization period 110 is a period during which a peer device (PD) synchronizes its timing with the network. In the synchronization period 110, each PD can transmit a synchronization signal to provide start timing of the frame.

In the discovery period 120, information about a service a PD can provide or information (i.e., discovery information) about a request for a service a PD wants to receive may be transmitted. In this period, the PD may determine whether it is connected to other PDs by using information transmitted by other PDs. That is, a PD included in a distributed network is able to perform discovery over the discovery period 120 before associating with the distributed network.

The peering period 130 is a period during which a PD establishes a link with other PDs. In this case, one PD may establish a link with one or more other PDs, and this PD may determine to establish a link over the discovery period 120.

The data communication period 140 is a period during which a PD transmits and receives data to and from at least one PD with which it establishes a link over the peering period 130.

According to an exemplary embodiment of the present invention, each synchronization interval 100 may include guard periods between each of the four periods including the synchronization period 110, the discovery period 120, the peering period 130, and the data communication period 140. The guard periods may be included between each of the four periods in the synchronization interval 100, to ensure reliability of synchronization between PDs in a distributed network where there is no centralized time reference. Each guard period may include at least one orthogonal frequency division multiplexing (OFDM) symbol or single carrier (SC) symbol.

According to an exemplary embodiment of the present invention, the synchronization period 110 of the synchronization interval 100 is at the beginning of the synchronization interval 100, and the order in which the discovery period 120, the peering period 130, and the data communication period 140 occur may be changed.

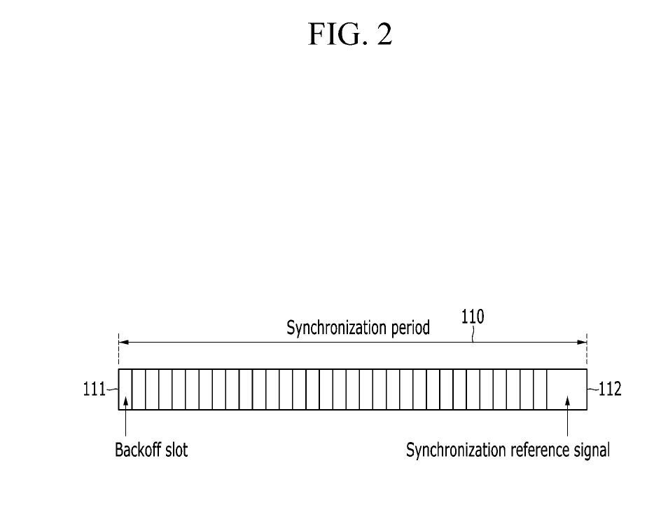

FIG. 2 is a view showing a synchronization period according to an exemplary embodiment of the present invention.

Referring to FIG. 2, the synchronization period 110 according to an exemplary embodiment of the present invention includes a part 112 during which a synchronization reference signal (SRS) is transmitted, and at least one backoff slot 111. The number of backoff slots 111 may be dynamically changed depending on the degree of network congestion, and each backoff slot 111 may include a plurality of OFDM symbols. For example, the synchronization period 110 may be 512 μsec long, the SRS may be 16 μsec long, there may be 32 backoff slots 111 in a synchronization period 110, each backoff slot 11 may be 16 μsec long, and each OFDM symbol or SC symbol may be 4 μsec long.

According to an exemplary embodiment of the present invention, a PD participating in a synchronization procedure may transmit an SRS by a random access method based on carrier sense multiple access with collision avoidance (CSMA-CA). The SRS transmitted by the PD may include a timing offset indication field (TOIF) and a guard time. In an exemplary embodiment of the present invention, the SRS may be a signal indicating that synchronization signals are correlated (commonality between PDs), or a signal indicating that synchronization signals are uncorrelated (orthogonality between PDs).

In this case, the timing offset indication field contains timing offset information regarding a timing offset of the frame. For example, the frame timing offset information may be the index of the slot during which the SRS is transmitted. In an exemplary embodiment of the present invention, the frame timing offset information may be used to synchronize the end of each synchronization interval. The timing offset information may be delivered through a message or using the orthogonality of a sequence provided by the physical layer. The timing offset information, if delivered using the orthogonality of a sequence, may be mapped to a specific orthogonal sequence. The timing offset information, if delivered through a message, may be carried in a message, and a PD, upon receiving this message, may recognize the timing offset information by restoring the message by channel decoding.

The backoff slot 111 in the synchronization period 110 during which no SRS is transmitted may be called a nulling period. The nulling period is for preventing collisions between synchronization signals from each PD.

A PD included in a network according to an exemplary embodiment of the present invention may perform fully distributed synchronization over the synchronization period 110. For example, when a plurality of PDs are in synchronization with each other, the PDs may respectively transmit synchronization reference signals 112 to keep them in synchronization. Alternatively, a plurality of PDs may be in synchronization with each other, and a PD that is dynamically elected from a PD group may transmit a synchronization reference signal 112.

According to an exemplary embodiment of the present invention, an initialized PD may search for network synchronization in the synchronization period 110, and if it discovers network synchronization, it may synchronize its timing with the network (synchronization maintenance mode). In this case, the PD according to the exemplary embodiment of the present invention may synchronize its timing with the network using a pulse-coupled oscillator (PCO) synchronization algorithm. Alternatively, if there is no network synchronization, the PD may transmit an SRS to start the initial synchronization mode.

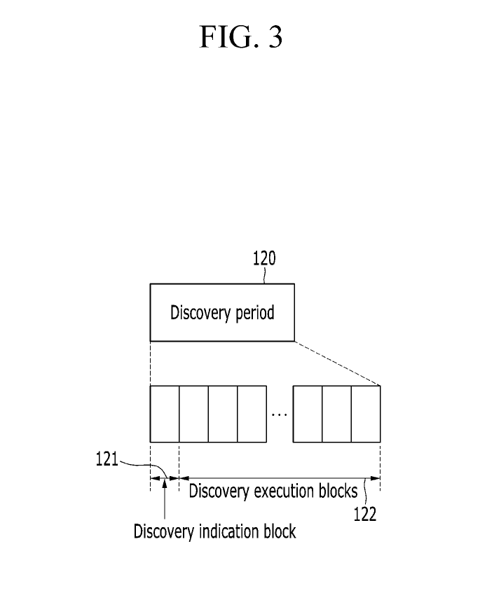

FIG. 3 is a view showing a discovery period according to an exemplary embodiment of the present invention.

Referring to FIG. 3, a discovery period 120 according to an exemplary embodiment of the present invention includes a discovery indication block 121 and discovery execution blocks 122. In the discovery indication block 121, a PD (serving terminal) that can provide a service or a PD (served terminal) wanting to receive a service may transmit any given signal. Upon receiving this signal, the PD may then recognize the existence of discovery information in the discovery execution blocks 122 by estimating the power level of the received signal. The discovery information may be information about an available service, or information about a request for a desired service. Having recognized the existence of discovery information in the discovery indication block 121, the PD may then execute a substantial discovery procedure in the discovery execution blocks 122.

Conventionally, a PD synchronized over the synchronization period 110 receives a discovery signal in the discovery period 120 to see if any discovery information exists, and if no discovery information about the provision of a desired service exists, may switch to sleep mode after the discovery period 120.

In this case, the PD may have to stay in listen mode throughout the entire discovery period 120 even when no discovery information exists, thus causing the PD to waste electricity.

However, in an exemplary embodiment of the present invention, each PD may reduce unnecessary waste of electricity by means of an indication block. In other words, in a synchronization interval according to an exemplary embodiment of the present invention, such a period as the discovery period 120 (hereinafter referred to as a ‘listen period’) during which a PD has to operate in listen mode includes an indication block at the beginning, and each PD may be recognize, through the indication block, whether information exists after this listen period. If a PD determines that information does not exist after the listen period, the PD may switch to and stay in sleep mode during the remaining part of the listen period.

In an exemplary embodiment of the present invention, the discovery period and the peering period are listen periods.

In an exemplary embodiment of the present invention, a signal transmitted in the discovery indication block 121 by a PD may be any physical layer signal. A PD that has received a signal in the discovery indication block 121 may estimate the energy of the received signal and recognize the existence of information in the discovery execution blocks 122.

For example, the energy of the received signal may be estimated from an average power level in the discovery indication block 121. After energy estimation, the PD compares an estimated power level with a predetermined threshold value. If the estimated power level is less than the threshold value, the PD determines that no information exists in the discovery block 22 and switches to sleep mode in the discovery execution blocks 122. In other words, a PD intending to request a service determines that there is no PD around it that provides the service, and does not transmit a discovery message containing a service request in the discovery execution blocks 122. Alternatively, a PD that can provide a service determines that there is no PD around it that requests the service, and does not transmit a discovery message containing information about the available service in the discovery execution blocks 122.

On the contrary, if the estimated power level is equal to or greater than the threshold value, then the PD determines that information in the discovery block 22 exists and stays on standby in the discovery execution blocks 122 for reception of information. Then, the PD may restore information transmitted in the discovery execution blocks 122 and check whether the restored information is discovery information about the service it has requested. Alternatively, the PD may restore information transmitted in the discovery execution blocks 122 and check whether discovery information about a service request exists.

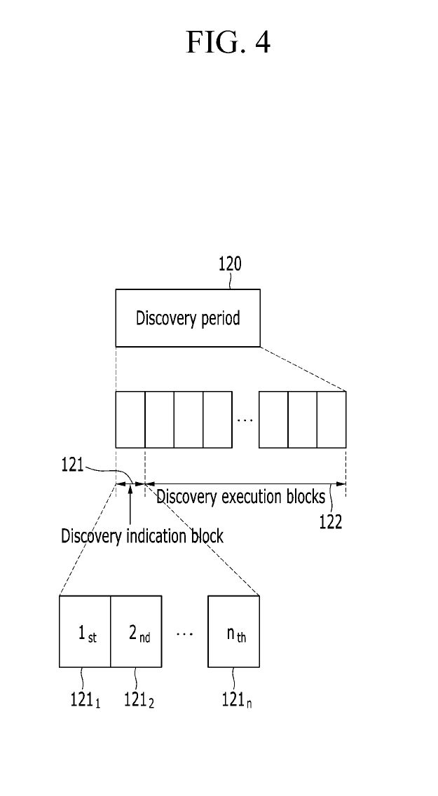

FIG. 4 is a view showing a discovery period according to another exemplary embodiment of the present invention.

Referring to FIG. 4, a discovery period 120 according to another exemplary embodiment of the present invention includes a discovery indication block 121 and discovery execution blocks 122, and the discovery indication block 121 includes a plurality of sub-blocks 121₁, 121₂, . . . , 121ₙ. The sub-blocks 121₁, 121₂, . . . , 121ₙ (state indication sub-block) included in the discovery indication block 121 according to another exemplary embodiment of the present invention may indicate a state of PDs. In another exemplary embodiment of the present invention, a PD may select one of the sub-blocks 121₁, 121₂, . . . , 121ₙ and transmit a physical layer signal thereto. As is the case with FIG. 3, the physical layer signal transmitted by the PD is a signal indicating the existence of discovery information in the discovery execution blocks 122 that follow.

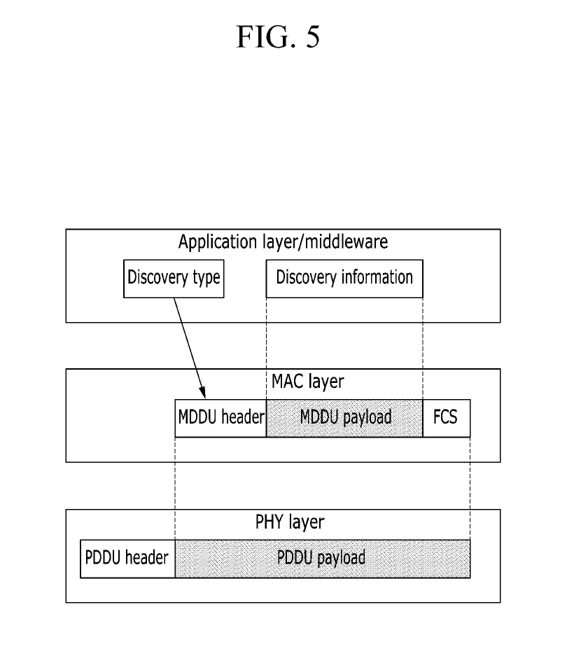

FIG. 5 is a view showing a protocol stack according to an exemplary embodiment of the present invention.

Referring to FIG. 5, an application layer or middleware generates discovery information and maps it to a MAC discovery data unit (MDDU) payload of the media access control (MAC) layer. In this case, a discovery type of the discovery information is mapped to an MDDU header of the MAC layer. The discovery type may include advertisement, publish and subscribe, and query and reply. In the MAC layer, frame check sequence (FCS) bits are added after the MDDU payload.

Afterwards, the MDDU header, MDDU payload, and FCS of the MAC layer may be mapped to a PHY discovery data unit (PDDU) payload in the physical (PHY) layer. In the PHY layer, a PDDU header may be added before the PDDU payload, and then the PDDU header and the PDDU payload may be mapped to one of the discovery execution blocks 122 included in the discovery period 120.

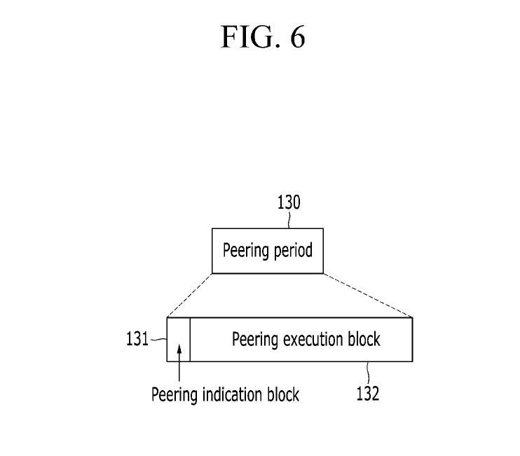

FIG. 6 is a view showing a peering period according to an exemplary embodiment of the present invention.

Referring to FIG. 6, the peering period 130, like the discovery period 120, includes a peering indication block 131 before a peering execution block 132. The peering period 130 is a listen period during which a PD wakes up and receives a signal. The peering indication block 131 plays the same role as the discovery indication block 121. In other words, a PD intending to perform peering may transmit any physical layer signal through the peering indication block 131, and a PD that has received the physical layer signal in the peering indication block 131 may recognize the existence of a PD intending to perform peering in the peering execution block 132. If a PD has not received any physical layer signal in the peering indication block 131, the PD may switch to sleep mode in the peering execution block 132.

As seen above, according to an exemplary embodiment of the present invention, a PD may selectively switch to sleep mode even in execution block of a listen period by recognizing the lack of information in the listen period, through an indication block included in the listen period. Therefore, power consumption can be reduced since the PD may switch to sleep mode even in the execution block of the listen period upon determining, through the indication block, that no information exists.

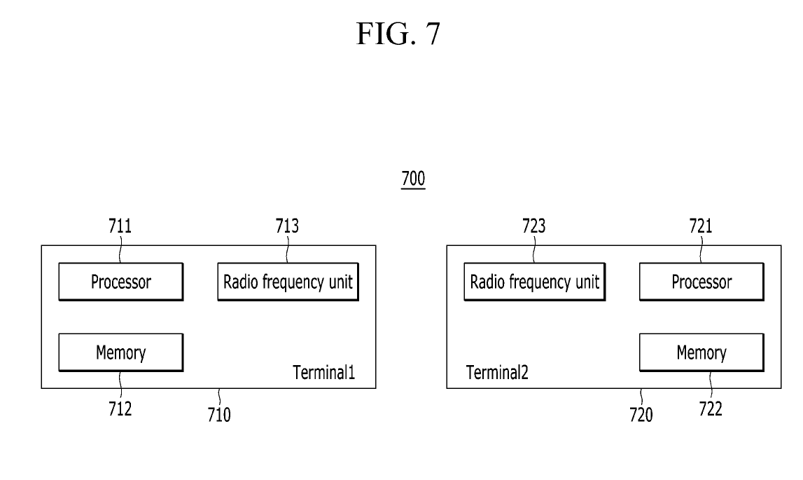

FIG. 7 is a block diagram showing a wireless communication system according to an exemplary embodiment of the present invention.

Referring to FIG. 7, a wireless communication system 700 according to an exemplary embodiment of the present invention includes a terminal1 710 and a terminal2 720 located near the terminal1 710.

The terminal1 710 and the terminal2 720 each includes a processor 711 (721), a memory 712 (722), and a radio frequency (RF) unit 713 (723). The memory 712 (722) may be connected to the processor 711 (721) and store various information for driving the processor 711 (721). The RF unit 713 (723) may be connected to the processor 711 (721) and transmit and receive a radio signal. The processor 711 (721) may implement the functions, processes, or methods proposed according to the embodiments of the present invention. In a wireless communication system according to an exemplary embodiment of the present invention, a radio interface protocol layer may be implemented by the processor 711 (721). Operations of the terminal1 710 (terminal2 720) according to the exemplary embodiment of the present invention may be realized by the processor 711 (721).

In the exemplary embodiment of the present invention, the memory may be inside or outside the processor, and the memory may be connected to the processor by various well-known means. The memory may be various types of volatile or nonvolatile storage media, and for example, may include read-only memory (ROM) or random access memory (RAM). While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for a terminal to recognize information contained in a frame, the method comprising:
performing synchronization over a synchronization period of the frame; and
recognizing, through an indication block of a listen period included in the frame, whether information in the remaining part of the listen period exists after the indication block.

2. The method of claim 1, wherein the recognizing comprises:
receiving a physical layer signal that is transmitted in the indication block; and
recognizing whether the information in the remaining part exists by the received power of the physical layer signal.

3. The method of claim 2, wherein the recognizing of whether information exists in the remaining part by the received power of the physical layer signal comprises:
comparing the received power of the physical layer signal with a threshold value;
determining that no information exists in the remaining part if the received power is less than the threshold value; and
determining that information exists in the remaining part if the received power is equal to or greater than the threshold value.

4. The method of claim 1, further comprising switching to and staying in sleep mode in the remaining part upon recognizing, through the indication block, that no information exists in the remaining part.

5. The method of claim 1, further comprising staying in listen mode in the remaining part upon recognizing, through the indication block, that information exists in the remaining part.

6. The method of claim 2, wherein the listen period is a discovery period, the indication block is a discovery indication block, and the remaining part comprises at least one discovery execution block.

7. The method of claim 6, wherein the discovery indication block comprises a plurality of sub-blocks for indicating the state of the terminal.

8. The method of claim 7, further comprising receiving the physical layer signal in one of the sub-blocks.

9. The method of claim 6, wherein one of the at least one discovery execution block comprises a physical discovery data unit (PDDU) and the header of the PDDU, and the PDDU includes discovery information and a discovery type.

10. The method of claim 2, wherein the listen period is a peering period, the indication block is a peering indication block, and the remaining part is a peering execution block.

11. A terminal comprising:
at least one processor;
a memory; and
a radio frequency unit,
wherein the at least one processor executes at least one program stored in the memory, and performs synchronization over a synchronization period of a frame, and recognizes, through an indication block of a listen period included in the frame, whether information exists in the remaining part of the listen period after the indication block.

12. The terminal of claim 11, wherein, in the recognizing, the at least one processor receives a physical layer signal that is transmitted in the indication block, and recognizes whether the information exists in the remaining part by the received power of the physical layer signal.

13. The terminal of claim 12, wherein, in the recognizing of whether information exists in the remaining part by the received power of the physical layer signal, the at least one processor compares the received power of the physical layer signal with a threshold value, determines that no information exists in the remaining part if the received power is less than the threshold value, and determining that information exists in the remaining part if the received power is equal to or greater than the threshold value.

14. The terminal of claim 11, wherein the at least one processor switching to and staying in sleep mode in the remaining part upon recognizing, through the indication block, that no information exists in the remaining part.

15. The terminal of claim 11, wherein the at least one processor stays in listen mode in the remaining part upon recognizing, through the indication block, that information exists in the remaining part.

16. The terminal of claim 12, wherein the listen period is a discovery period, the indication block is a discovery indication block, and the remaining part comprises at least one discovery execution block.

17. The terminal of claim 16, wherein the discovery indication block comprises a plurality of sub-blocks for indicating the state of the terminal.

18. The terminal of claim 17, wherein the radio frequency unit receives the physical layer signal in one of the sub-blocks.

19. The terminal of claim 16, wherein one of the at least one discovery execution block comprises a physical discovery data unit (PDDU) and the header of the PDDU, the PDDU includes discovery information and a discovery type.

20. The terminal of claim 12, wherein the listen period is a peering period, the indication block is a peering indication block, and the remaining part is a peering execution block.
